(19) United States
(12) Patent Application Publication
(10) Pub. No.: US 2003/0009926 A1
(43) Pub. Date: Jan. 16, 2003

(54) Fishing lure obstruction freeing apparatus

(76) Inventor: Mary C. Frederickson, Sedona, AZ (US)

Correspondence Address: H. GORDON SHIELDS, 7830 NORTH 23RD AVENUE, PHOENIX, AZ, 85021, US

(21) Appl. No.: 09/904,122

(22) Filed: Jul. 13, 2001

(51) Int. Cl. A01K 85/00

(52) U.S. Cl. 43/42

(57) ABSTRACT

Apparatus for freeing a lure and its hook or hooks from weeds or other obstructions includes a sleeve to which are secured chain elements. A line is also secured to the sleeve and the line extends to a reel. A slit extends along the sleeve for receiving the fishing line secured to the lure and hooks. The sleeve is lowered on the fishing line and is moved or “bounced” up and down on the fishing line to free the lure and hooks. The movement of the chain elements against the weeds or other obstruction frees the lure and its hook or hooks.

### BACKGROUND OF THE INVENTION

1. Field of the Invention

This invention relates to fishing lures and, more particularly, to apparatus for freeing fishing lures caught on rocks, weeds, and the like.

2. Description of the Prior Art

“Water dog bombers” and other “Repala” type lures are used to catch certain types of fishes. The lures are designed to sink to the bottom of lakes or streams and, as they are dragged along, may get caught on rocks, weeds, and the like. Freeing lures from such obstacles is a constant problem.

Trying to back the lure up, to move it away from obstructions, or simply pulling on the fishing line in an attempt to free the lure, are two prior art ways of freeing the lures. Both such prior art methods have varying degrees of success, and not untypically may result in the loss of the lure by simply breaking the fishing line.

The apparatus of the present invention provides apparatus for freeing the lures without harm to the lures.

### SUMMARY OF THE INVENTION

The invention described and claimed herein comprises a sleeve tied to a line and with a longitudinally extending slot to allow the sleeve to be placed over a fishing line. Chains are secured to the sleeve remote from the sleeve location at which the line is secured. The sleeve is then allowed to move downwardly over the fishing line and, upon contact with the obstruction blocking the lure, is moved up and down and around by movement of its tethering line. The action of the chains and the cylinder frees the lure. With the lure free, both the lure and the sleeve are raised.

Among the objects of the present invention are the following:

To provide new and useful apparatus to free fishing lures caught on obstructions;

To provide new and useful apparatus including a cylinder secured to a line and having a slot in the sleeve to allow the sleeve to be placed over the fishing line;

To provide new and useful sleeve apparatus including a plurality of chains secured to the sleeve for freeing a fishing lure caught on an obstruction; and

To provide new and useful fishing lure freeing apparatus including a plurality of chains having barbs thereon secured to a sleeve having a slot for receiving a fishing line for movement of the sleeve on the fishing line of a trapped lure.

### BRIEF DESCRIPTION OF THE DRAWING

FIG. 1 is a perspective view of the apparatus of the present invention.

FIG. 2 is a perspective view of an alternate embodiment of the apparatus of FIG. 1.

### DESCRIPTION OF THE PREFERRED EMBODIMENT

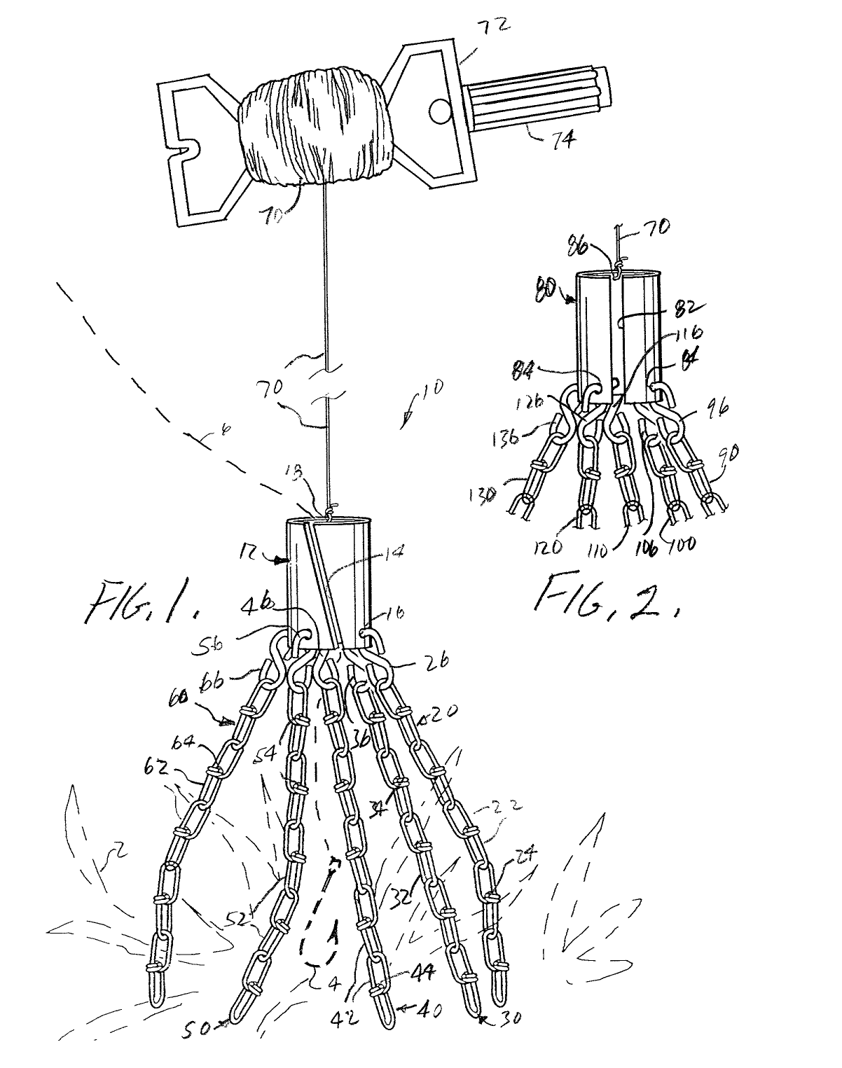

FIG. 1 is a perspective view of the apparatus of the present invention in its use environment, namely in a stream or lake where a hook 4 is caught in weeds 2. As is well known and understood, the hook 4 is secured to a lure. However, for purposes of convenience and clarity, the lure has been omitted. As may be understood, a lure may include more than one hook. Again, for convenience and clarity, only a single hook is illustrated in FIG. 1.

Fishing lure obstruction freeing apparatus 10 of the present invention is shown adjacent to the hook 4 among the weeds 2. The apparatus 10 includes a sleeve 12, which is preferably made of stainless steel or other metal having a non-rusting coating. The sleeve is generally about two inches long and about an inch and a half in diameter. Extending diagonally with respect to the longitudinal axis of the sleeve is a slit or slot 14. The slit 14 receives a fishing line 6 which is secured to the lure and the hook 4. The slit 14 is relatively narrow so as to allow the fishing line to move into the sleeve 12 with relative ease, but is not so wide as to allow the line 6 to easily come out of the sleeve during either the movement of the sleeve downwardly on the line 6 and during the jerking or other movement of the sleeve 12, as will be discussed below.

Generally speaking, the greater the diagonal angle of the slit 14, the less the likelihood of the line 6 coming out of the sleeve during use. However, there is a practical aspect to the angle of slit, also. In other words, the slit is a generally straight diagonally extending slit, and need not be a curved slit or a slit extending at an impractical diagonal angle.

At the lower portion of the sleeve 10 are lower apertures 16 to which are secured five chain elements 20, 30, 40, 50, and 60. The chain elements include a plurality of links, each of which include barbs. At the upper portion of the sleeve 12, and diametrically opposite to the slot 14, is an upper aperture 18 to which is secured a line 70.

The chain 20 element is secured to the sleeve 12 through an s-hook 26. The s-hook 26 extends through one of the lower apertures 16. The chain element 20 includes a plurality of links 22, each of which includes a barb 24.

The chain element 30 is secured to the sleeve 12 by an s-hook 36. The s-hook 36 is in turn secured to one of the lower apertures 16. The chain element 30 includes a plurality of links 32, each of which includes a barb 34.

The chain element 40 is substantially like the chain elements 20 and 30, in that it includes a plurality of links 32, each of which links includes a barb 34. The chain element 40 is secured to the sleeve 12 through an s-hook 46. The s-hook 46 is secured to the sleeve 12 at one of the lower apertures 16.

A fourth chain element 50 is shown secured to the sleeve 12 by an s-hook 56. The s-hook 56 is secured to the sleeve 12 at a lower aperture 16. The chain element 50 includes a plurality of links 52, each of which includes a barb 54.

A fifth chain element 60 is, like the other four chain elements, secured to the sleeve 12 by an s-hook, an s-hook 66. The s-hook 60 is secured to the sleeve at a lower aperture (not shown) on the sleeve. The chain element 60 includes a plurality of links 62, each of which links includes a barb 64.

The chain elements 20, 30, 40, 50, and 60 are spaced apart from each other at the lower portion of the sleeve 12, remote from where the line 70 is secured to the sleeve. With five chain elements illustrated, the chain elements are spaced apart about seventy two degrees from each other. The chain elements are typically about six inches long, and they are preferably each about the same length. Also, by being about the same weight and spaced apart generally symmetrically relative to the sleeve 12, the chains do not interfere with the natural cant or tilt of the sleeve 12 on the line 70, which helps to insure that the line 70 remains generally away from the slit 14. This will be discussed below.

The chains 20, 30, 40, 50, and 60 are secured to the sleeve 12 at the lower part of the sleeve, thus remote from where the line 70 is secured to the sleeve.

The line 70 is secured to the sleeve 12 generally diametrically opposite from the slit 14. The line 70 extends to a reel 72 where it is appropriately wound. The reel 72 includes a handle 74 for convenience in winding and unwinding the line 70.

For use, when the lure and hook 4 is caught in weeds or other obstructions, etc., the sleeve 12 is disposed about the line 6 by inserting the line 6 through the slit 14. With the line 70 opposite the slit 14, there is an inherent canting or tilting of the sleeve 12. With the chains 20, 30, 40, 50 and 60 secured to the lower portion of the sleeve generally symmetrically, they have no effect on the location of the line 6 relative to the sleeve 12. Accordingly, the line 6 is in the sleeve 12 generally away from the slit 14. This helps to prevent the line 6 from coming out of the sleeve 12 through the slit 14.

The sleeve 12, with its chain elements 20 . . . 60, is then lowered on the line 6 from the reel 72 until the sleeve 12 is essentially resting on or against the lure and hook 4 in the weeds 2, or against an obstruction on which a hook 4 is caught. The line 70 is then “bounced,” or jerked or moved up and down slightly in order for the chain elements to catch against the weeds or obstruction and free the lure and hook 4.

By tugging on the line 6, the user of the apparatus 10 will know when the lure and hook 4 is free from the weeds 2. That is, the movement of the apparatus 10 is typically accompanied by the tugging on the line 6. When the line 6 is free from the weeds 2, the line 6 will rise in response to the tugging and the sleeve 12 may then be raised by reeling up the line 70 onto the reel 72.

An alternate embodiment of the sleeve 12 is shown in FIG. 2. FIG. 2 is a perspective view of an alternate sleeve 80. The sleeve 80 includes a generally axially extending slit 82, as opposed to the diagonally extending slit 14 of the apparatus 10. The sleeve 80 includes the lower apertures to which chains or chain elements are appropriately secured through s-hooks or the like. The line 70 is secured to the sleeve 80 through an upper aperture which is diametrically aligned opposite to the slit 82.

Again, the slit 82 is rather narrow, or just wide enough to facilitate the entry of a fishing line, such as the line 6, into the sleeve 80.

Secured to the sleeve 80 are five chain elements 90, 100, 110, 120, and 130. The chain elements 90 . . . 130 are secured to the sleeve 80 at the lower portion of the sleeve, remote from where the line 70 is secured. The chain elements 90, 100, 110, 120, and 130 are secured through s-hooks 96, 106, 116, 126, and 136, respectively.

Again, the chain elements and their respective s-hooks are disposed about the lower periphery of the sleeve 80, just as the chain elements of the apparatus 10 are secured to the sleeve 12. The chain elements are also preferably spaced apart generally equally distant from each other, or about seventy two degrees apart from adjacent chain elements.

As referred to above, the slit in the sleeve may also be curved, either generally axially extending or diagonally extending, which may substantially decrease the likelihood of a fishing line coming out of a sleeve through a slit. However, such structure is relatively expensive to machine, and thus may be rather impractical, especially since a relatively straight diagonal slit appears to be quite satisfactory.

It will be noted that the chains illustrated in the drawing Figures and discussed above are of generally equal length. However, it may be advantageous to have one or more of the chains shorter than the suggested six inches. In such case, perhaps a shorter chain may be disposed between a pair of the longer chains in an alternate length arrangement. The shorter chain or chains will probably be shorter by only about a single link.

Also, while five chain elements have been illustrated and discussed, with a sleeve of a specified diameter, the use of a smaller diameter sleeve may require fewer chain elements, while more chain elements may be used on a larger diameter sleeve. However, the sleeve size and chain elements discussed above appear satisfactory and preferable for most lake and stream fishing applications.

While the principles of the invention have been made clear in illustrative embodiments, there will be immediately obvious to those skilled in the art many modifications of structure, arrangement, proportions, the elements, materials, and components used in the practice of the invention, and otherwise, which are particularly adapted to specific environments and operative requirements without departing from those principles. The appended claims are intended to cover and embrace any and all such modifications, within the limits only of the true spirit and scope of the invention.

What I claim is:

1. Apparatus for freeing a fishing lure and hook from obstructions comprising in combination:
a sleeve;
a slit in the sleeve for receiving a fishing line secured to the lure;
a plurality of chain elements secured to the sleeve; and
a line secured to the sleeve for lowering the sleeve on the fishing line and its chain elements to free the lure from obstructions.

2. The apparatus of claim 1 in which the chain elements include a plurality of links.

3. The apparatus of claim 2 in which the links of the chain elements include barbs.

4. The apparatus of claim 1 which further includes a reel on which the line secured to the sleeve is wound.

5. The apparatus of claim 4 in which the reel includes a handle for holding the reel and the line wound about the reel.

6. The apparatus of claim 1 in which the sleeve includes a longitudinal axis, and the slit in the sleeve extends diagonally with respect the longitudinal axis.

7. The apparatus of claim 1 in which the sleeve includes a longitudinal axis and the slit is generally parallel to the longitudinal axis.

8. The apparatus of claim 1 in which the sleeve has a diameter, and the line is secured to the sleeve diametrically opposed to the slit.

9. The apparatus of claim 1 in which the plurality of chain elements comprises five chain elements, each of which chain elements includes a plurality of links.

10. The apparatus of claim 9 in which each link includes a barb.
